(19) United States
(12) Patent Application Publication
(10) Pub. No.: US 2017/0241131 A1
(43) Pub. Date: Aug. 24, 2017

(54) SYSTEM AND METHOD FOR PROVIDING EXTERIOR INSULATION AND FINISHING FOR A BUILDING

(71) Applicant: Joseph Lewis, Cave Creek, AZ (US)

(72) Inventor: JOSEPH LEWIS, Cave Creek, AZ (US)

(21) Appl. No.: 15/432,775

(22) Filed: Feb. 14, 2017

Related U.S. Application Data
(60) Provisional application No. 62/297,372, filed on Feb. 19, 2016.

(51) Int. Cl. E04B 1/76; B05B 3/00; B05D 1/02; E04B 1/78; E04B 1/88

(52) U.S. Cl. CPC E04B 1/7625; E04B 1/78; E04B 1/88; B05D 1/02; B05B 3/00; E04B 2001/742

(57) ABSTRACT

Provided is a system and method for a providing exterior insulation and finishing for a building. More specifically, the system for providing exterior insulation and finishing for a building, includes: backing material to be affixed to an exterior wall structure, the backing material suitable to receive closed cell spray foam; a reservoir of closed cell spray foam to be applied by a sprayer to the backing material when adjoined to an exterior wall surface; at least one shaping device structured and arranged to shape the closed cell spray foam after application to the wall surface; and a reservoir of weather resistant barrier material to be applied by a sprayer to the shaped closed cell spray foam. An associated method of use is also provided.

### CROSS REFERENCE TO RELATED APPLICATIONS

This application claims the benefit under 35 U.S.C. §119(e) of U.S. Provisional Application No. 62/297,372 filed Feb. 19, 2016 and entitled SYSTEM AND METHOD FOR PROVIDING EXTERIOR INSULATION AND FINISHING FOR A BUILDING, the disclosure of which is incorporated herein by reference.

### FIELD OF THE INVENTION

The present invention relates generally to exterior building siding and insulation systems, and more specifically to a system and method for exterior spray applied insulation and finishing materials.

### BACKGROUND

Protecting the exterior of a building such as a residence or commercial structure has long been an issue of concern. In addition, to provide a pleasing and hospitable environment within the building, insulation within walls and ceilings is often used. This in-wall insulation typically reduces heating and cooling costs within the building by helping to reduce temperature swings within the building as the weather conditions change outside.

The exterior of the building generally serves to protect the building structure from the elements, and most specifically water. The unintended introduction of water into a building can be detrimental as it may lead to rot, mold, degradation of the wood, metal or other materials used to construct the building, as well as other issues.

As such, achieving a protective exterior, and a waterproofed interior, are generally important issues regarding general wall construction of buildings.

The traditional methodology of installing a water-managed exterior insulation system consists of: sheathing (exterior grade OSB, Plywood, gypsum board, fiberglass, etc.) mechanically attached to the wall/exterior framing. Next, a moisture barrier (Water Resistive Barrier—WRB) will cover all of the sheathing with a prescribed mesh tape over joints, and a liquid and/or sheet product (e.g. Tyvek®) will be applied over the sheathing.

The addition of furring strips/battens is then added to the wall to create an airspace between the sheathing/WRB and the sheets of expanded polystyrene (EPS) which are attached to the substrate/furring strips/battens.

Next, fiberglass mesh will be embedded in a nominal basecoat ( 1/16″) of material. This fiberglass mesh application will typically receive multiple layers of coating for additional impact resistance. The wall will include through wall flashing as required as well as weep holes allowing any water which has penetrated the system to adequately drain from the WRB to the outside. This application may then be hand finished/troweled prior to receiving a finish coat of exterior grade paint, where applicable.

The described method presents many challenges in its practice. The method, or system, uses many pieces and parts. In addition, in many cases the process to apply them all cannot easily be done in the same day. This time delay is a further problem as it allows water to penetrate the system over the course of the multiple days while the project is unfinished.

Additionally, even when the application is complete, the systems allows for thermal bridging to occur which creates a reduction in the overall insulation value of the complete exterior system. Yet a further problem is that traditional systems such as this are water-based and may only be installed when the temperature is well above freezing, thus limiting the available time throughout the year when construction may take place. And further still, traditional systems are also subject to cracking, damage, or degradation from freeze/thaw cycles. In some cases, during the life of a building it may be necessary to remove and replace the exterior materials.

Hence there is a need for a method and system that is capable of overcoming one or more of the above identified challenges.

### SUMMARY OF THE INVENTION

Our invention solves the problems of the prior art by providing novel systems and methods for providing exterior insulation and finishing for a building.

In particular, and by way of example only, according to one embodiment of the present invention, provided is a method for providing exterior insulation and finishing for a building, including: preparing an exterior wall surface of a building to accept closed cell spray foam; applying closed cell spray foam upon the prepared exterior wall surface; shaping the applied closed cell spray foam upon the prepared exterior wall surface to a desired thickness; applying a weather resistant barrier over the shaped closed cell spray foam; and painting the applied weather resistant barrier with an exterior grade paint.

In yet another embodiment, provided is a system for providing exterior insulation and finishing for a building, including: backing material to be affixed to an exterior wall structure, the backing material suitable to receive closed cell spray foam; a reservoir of closed cell spray foam to be applied by a sprayer to the backing material when adjoined to an exterior wall surface; at least one shaping device structured and arranged to shape the closed cell spray foam after application to the wall surface; and a reservoir of weather resistant barrier material to be applied by a sprayer to the shaped closed cell spray foam.

Still, for yet another embodiment, provided is a system for providing exterior insulation and finishing for a building, including: backing material to be affixed to an exterior wall structure, the backing material suitable to receive closed cell spray foam; a reservoir of closed cell spray foam to be applied by a sprayer to the backing material when adjoined to an exterior wall surface; at least one shaping device structured and arranged to shape the closed cell spray foam after application to the wall surface; tract guides structured and arranged for temporary attachment adjacent to the exterior wall surface, the tract guides facilitating consistent shaping of the applied closed cell spray foam by the shaping device; and a reservoir of weather resistant barrier material to be applied by a sprayer to the shaped closed cell spray foam.

### BRIEF DESCRIPTION OF THE DRAWINGS

FIG. 1A shows the general elements for a system for providing exterior insulation and finishing for a building and FIG. 1B is a perspective drawings of an exemplary building, the exterior of which may be provided insulation and finishing in accordance at least one embodiment of the present invention;

FIG. 2 is a high level flow diagram for a method of applying exterior insulation and finishing for a building in accordance with at least one embodiment of the present invention;

FIG. 3A is a perspective of two of the exterior walls of the dwelling shown in FIG. 1, FIG. 3B being a top view, each view showing the application of backing material in accordance at least one embodiment of the present invention;

FIGS. 4A and 4B are perspective and top views of wall elements show in FIGS. 3A and 3B with the backing material disposed thereupon in accordance at least one embodiment of the present invention;

FIG. 5 is a perspective view of the wall elements shown in FIGS. 4A and 4B receiving an application of closed cell spray foam in accordance at least one embodiment of the present invention;

FIGS. 6A and 6B are perspective and top views of the wall elements shown in FIG. 5 further showing complete application of the closed cell spray foam to one wall element in accordance at least one embodiment of the present invention;

FIG. 7 is a perspective view of the wall elements shown in FIG. 6A further showing an application of closed cell spray foam to the second wall element in accordance at least one embodiment of the present invention;

FIG. 8 is a perspective view of the wall elements shown in FIG. 7 showing generally complete application of the closed cell spray foam in accordance at least one embodiment of the present invention;

FIGS. 9A, 9B, and 9C show respectively top and perspective views of a shaver being applied and used to shave the sprayed on closed cell spray foam in accordance at least one embodiment of the present invention;

FIGS. 10A and 10B are perspective and top views of the wall elements shown in FIG. 9B showing the resulting shaved state of the sprayed on closed cell spray foam in accordance at least one embodiment of the present invention;

FIG. 11 is a perspective view of the wall elements shown in FIG. 10B showing optional shaping of the sprayed on closed cell spray foam to appear as traditional building siding such as stone or brick in accordance at least one embodiment of the present invention;

FIG. 12 is a perspective view of the wall elements shown in FIG. 10B showing the application of water resistant barrier material to the shaved/shaped sprayed on closed cell spray foam in accordance at least one embodiment of the present invention;

FIG. 13 is a perspective view of the wall elements shown in FIG. 12 now with a complete coating of the of water resistant barrier material to the shaved/shaped sprayed on closed cell spray foam in accordance at least one embodiment of the present invention; and

FIG. 14 is a perspective view of the wall elements shown in FIG. 13 now with a complete coating of exterior paint applied over the water resistant barrier material disposed upon the shaved/shaped sprayed on closed cell spray foam in accordance at least one embodiment of the present invention.

### DETAILED DESCRIPTION

Before proceeding with the detailed description, it is to be appreciated that the present teaching is by way of example only, not by limitation. The concepts herein are not limited to use or application with a specific system or method for exterior walls. Thus, although the instrumentalities described herein are for the convenience of explanation shown and described with respect to exemplary embodiments, it will be understood and appreciated that the principles herein may be applied equally in other types of systems and methods involving exterior siding.

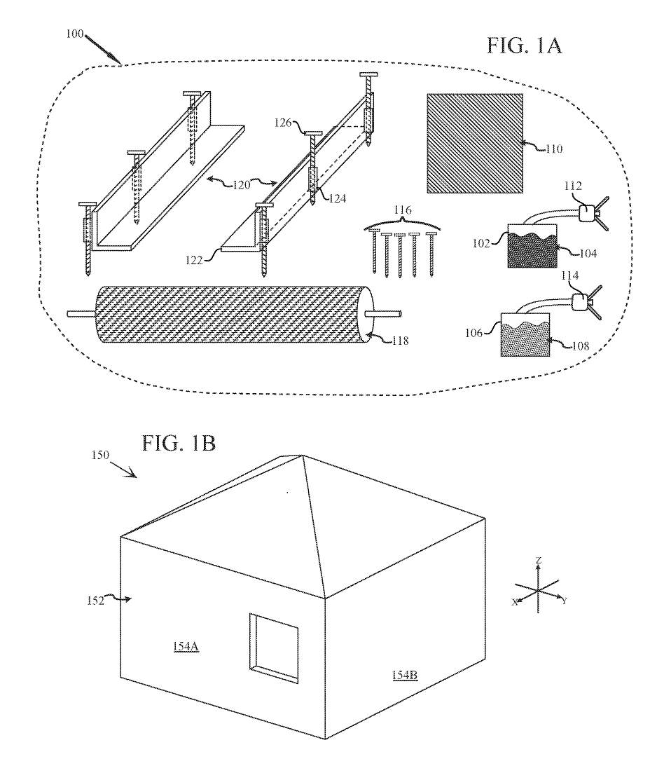

This invention is described with respect to preferred embodiments in the following description with reference to the Figures, in which like numbers represent the same or similar elements. Further, with the respect to the numbering of the same or similar elements, it will be appreciated that the leading values identify the Figure in which the element is first identified and described, e.g., element 100 appears in FIG. 1.

To briefly summarize, with reference to FIGS. 1-16, described are a system and method for providing exterior insulation and finishing for a building, comprising: preparing an exterior wall surface of a building to accept closed cell spray foam; applying closed cell spray foam upon the prepared exterior wall surface; shaping the applied closed cell spray foam upon the prepared exterior wall surface to a desired thickness; applying a weather resistant barrier over the shaped closed cell spray foam; and painting the applied weather resistant barrier with an exterior grade paint.

Turning now to FIG. 1 there are shown the elements for a system for Providing Exterior Insulation and Finishing, hereinafter SEIF 100, in accordance with at least one embodiment. It will also be appreciated that this SEIF 100 may be considered a kit. Moreover, in at least one embodiment the invention is provided in the form of a system that includes the use of existing technologies not previously used in the proposed configuration. The primary area of technology includes the method, apparatus and materials necessary to apply closed cell polyurethane [spray] foam, polyurea, and exterior grade paint, tinted to suit, as a exterior insulation and finished siding.

More specifically, for at least one embodiment, SEIF 100 includes at least one reservoir 102 of closed cell spray foam 104, at least one reservoir 106 of weather resistant barrier material 108, and backing material 110. One or more spraying systems, such as exemplary sprayers 112 and 114 for the application of the closed cell spray foam 104 and or the barrier material 108 may also be provided.

The backing material 110 is a material suitable for attachment to an exterior wall structure and to receive the closed cell spray foam 104. This backing material 110 may be selected from, but not exclusively limited to, exterior grade Oriented Strand Board “OSB”, plywood, brick, Concrete Masonry Unit(s) “CMU”, and landscape fabric. Of course combinations of these materials may be used as desired without departing from the scope of the present invention.

For at least one embodiment, the closed cell spray foam 104 is closed cell polyurethane spray foam, such as, but not limited to the commercially available product SWD Quik Shield 112 Closed Cell Spray Foam, such as may be obtained from SWD Urethane of Mesa, Ariz. Moreover, for at least one embodiment the closed cell spray foam 104 is a non water-based product and as such is not susceptible to the temperature constraints of a water-based product. In addition, for at least one embodiment, the weather resistant barrier material 108 is polyuria product, such as, but not limited to the commercially available product SWD Quik Shield 931 polyurethane Polyurea Hybrid Coating, such as may be obtained from SWD Urethane of Mesa, Ariz.

Varying embodiments, SEIF 100 may also include a plurality of depth guides 116 for temporary attachment to the exterior wall, or guide posts disposed adjacent thereto, and for use in ensuring the application of the closed cell spray foam 104 to the desired depth/thickness, at least one shaping device 118 to shape and/or shave the closed cell spray foam 104 after application to a surface, and track guides 120. More specifically the track guides 120 are structured and arranged for temporary attachment to the exterior wall, or guideposts disposed adjacent thereto, to facilitate consistent shaping of the applied closed cell spray foam 104 by the shaping device 118.

For at least one embodiment, at least one or more shaping devices 118 are C I Cutters as may be purchased from Schmidt & Dirks Design, Inc., of Moscow, Id., and or the Poly-Plane, or Poly-Plane2 as may be ordered from Demand Products of Alpharetta, Ga. In addition, shaping devices 118, such as but not limited to hand sanders, orbiter sanders, and drum sanders/shavers may also be used as one or more shaping devices 118.

For at least one embodiment, the track guides 120 are provided by angle iron, or aluminum “L” channels 122 having a plurality of threaded sleeves 124, each sleeve 124 set to receive a threaded bolt 126. For at least one embodiment, the threaded sleeves 124 may be directly affixed to the channels 122. For at least one alternative embodiment, the threaded sleeves 124 may be disposed between bushings or bearings that are affixed to the channels such that a sleeve 124 may be rotated independently from it's respective bolt 126.

In operation, the relative height of the track guides 120 from the initial exterior surface can be selected and set by varying the threaded length of each bolt 126 as it passes through each sleeve 124. Indeed, initial surface irregularities can be mitigated, and/or the resulting exterior surface to be provided may be established to be parallel to, or sloped towards or away from the initial exterior surface of the building.

For at least one embodiment, the track guides 120 may be initially set and used as depth guides during the application of the closed cell spray foam 104, before being used for the guidance of the shaping device 118. And, of course, it will be understood and appreciated that the height of the track guides 120 may be changed between their use as depth guides during the application of the closed cell spray foam 104 and their use for the guidance of the shaping device 118.

Moreover, to summarize, for at least one embodiment SEIF 100 includes: backing material 110 to be affixed to an exterior wall structure, the backing material 110 suitable to receive closed cell spray foam; a reservoir 102 of closed cell spray foam 104 to be applied by a sprayer 112 to the backing material 110 when adjoined to an exterior wall surface; at least one shaping device 118 structured and arranged to shape the closed cell spray foam 104 after application to the wall surface; and a reservoir 106 of weather resistant barrier material 108 to be applied by a sprayer 114 to the shaped closed cell spray foam 104. This embodiment of SEIF 100 may be further augmented by the addition of depth guides 116 and/or track guides 120.

To facilitate the further description of SEIF 100 and at methods for providing exterior insulation and finishing to a building, also presented in FIG. 1B is an exemplary building 150, having a plurality of external walls 152, each with an initial exterior surface 154, of which initial external wall surfaces 154A and 154B are exemplary. It should be understood and appreciated that the disclosed system and method for providing exterior insulation and finishing are not limited to a specific type of building or structure.

To facilitate the description of the systems and methods for providing exterior insulation and finishing, the orientation of the external wall surfaces 154 as presented in the figures are referenced to the coordinate system with three axes orthogonal to one another as shown in FIG. 1B. These axes intersect mutually at the origin of the coordinate system, which is chosen to be the center of the building 150, however the axes shown in all figures are offset from their actual locations for clarity and ease of illustration.

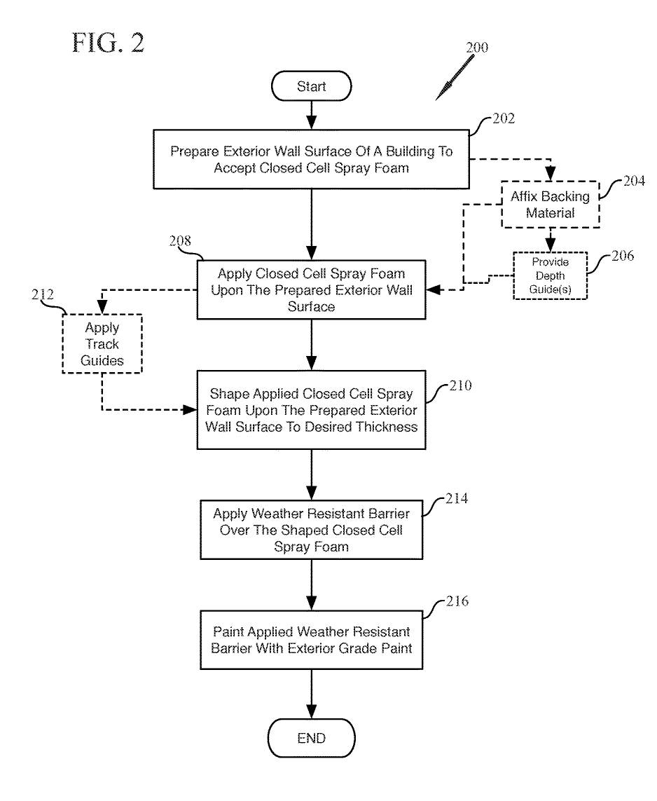

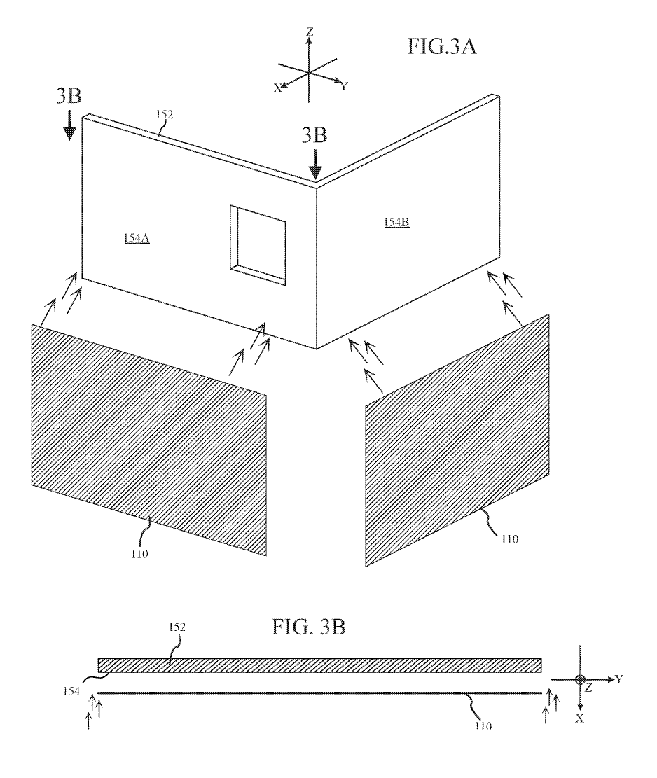

Use of SEIF 100 and indeed at least one method 200 of using SEIF 100 will now be discussed with respect to the elements of FIG. 1, the flow diagram of FIG. 2, and FIGS. 3-14. It will be understood and appreciated that the described method 200 need not be performed in the order in which it is herein described, but that this is merely exemplary of one method for using SEIF 100.

More specifically, it will be understood and appreciated that the present invention advantageously provides a robust exterior for a building 150, the exterior being structured and arranged to mimic the appearance of more traditional building siding, and to provide insulation for the building 150. Although more traditional “in wall” insulation may be used, or previously exist within the wall, the closed cell spray foam 104 as applied to form the exterior of the building 150 inherently also provides an advantageous insulating property.

A advantageous feature of the present invention is that it reduces the number of steps traditionally required to install an exterior insulation and finish system to three (3) main or parent steps: those being:

1.) Application of the closed cell spray foam over a suitable backing material;

2.) Application of a weather barrier coating over the closed cell spray foam; and

3.) A final coating of exterior grade paint tinted to suit the home or building.

Moreover, in sharp and advantageous contrast to conventional exterior finishing systems and methods, under the present invention there is no need for fasteners, wire mesh, skrim, WRB, EPS, furring/batten strips, weep holes, or the like to be installed prior to or during the practice of the described system and method.

Termination bar or weep screeds, termite inspection strips, etc. may be installed as needed as those skilled in the art will appreciate. Additionally, SEIF 100 and the practice of method 200 will achieve an air, water, moisture, and thermally managed, monolithic exterior wall, insulation, and finish system. Additionally, the nature of the closed cell spray foam 104 and weather resistant barrier material 108 as non-water based products, allows the application temperatures to extend well below freezing thus opening up more workable [seasonable] times and climate zones within the industry. For example, climate zones that historically have been unable to utilize a stucco type finishing system may utilize embodiments SEIF 100 and the practice of method 200 as the closed cell spray foam 104 and weather resistant barrier material 108 coating are each non water-based products, permitting application to the building 150 at temperatures below the freezing point of water, generally understood as 32 degrees Fahrenheit.

Turning now to FIG. 2, in general, the method 200 of using SEIF 100, commences with preparing the initial exterior wall surface 154 of a building 150 to accept closed cell spray foam 104, block 202. More simply stated, to effectively apply the closed cell spray foam 104 requires the building's initial exterior to provide a substrate or material acceptable to having closed cell spray foam 104 adhere to it. This substrate may in some instances already exist, or it may be provided by a backing material 110, optional block 204, that is fastened to the exterior wall/framing using methods well know to those skilled in the art. The substrate may be a cloth-type material, or a panel type surface.

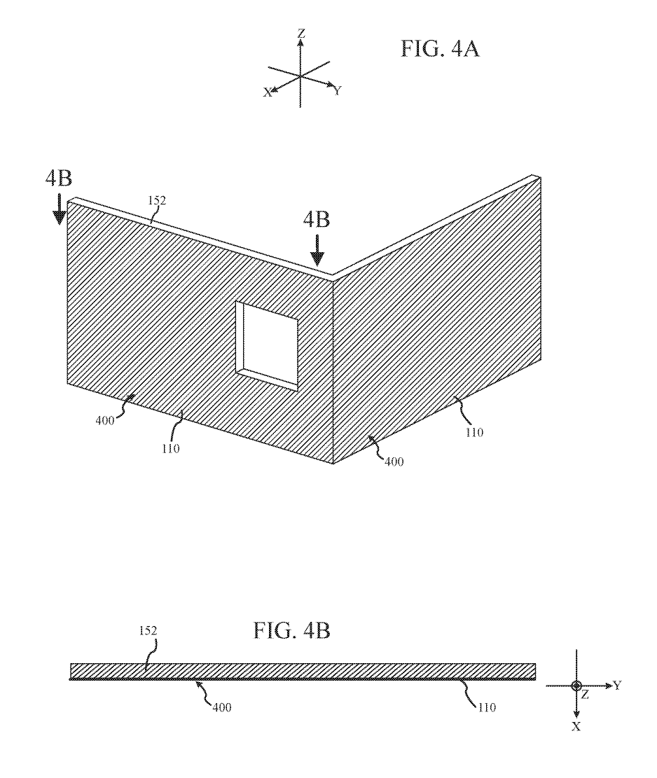

This process is further shown in FIGS. 3A and 3B, wherein the backing material 110 is being applied to the initial exterior wall surfaces 154A and 154B. FIGS. 4A and 4B further show the backing material 110 now affixed to the walls and providing a closed cell spray foam 104 receiving surface 400. It should be noted that the backing material 110, even when a flexible material such as landscaping fabric, may cover holes, openings, defects or other elements without issue, that otherwise might pose a structural issue of concern for more traditional exterior finishing. Moreover, as the closed cell spray foam 104 will cure to have a substantially ridged structure, in some cases the closed cell spray foam 104 itself will often impart an element of structural rigidity to the building.

As noted above and shown in FIG. 2, method 200 permits the optional providing of depth gages, block 206, to assist in the certainty of applying the closed cell spray foam 104 to about a desired depth. Although a minimum value of depth for the closed cell spray foam 104 may be may as thin as one inch or less, the thickness of the closed cell spray foam 104 has a direct correlation on the insulation value of the applied closed cell polyurethane foam. Therefore, the actual thickness of the closed cell spray foam 104 is chosen depending on the climate zone and other factors to achieve prescriptive or performance based R-Values as set forth by local building or energy code.

In some applications, 4″ of the closed cell spray foam 104 may be considered to be a typical thickness to achieve acceptable thermal performance, however, those skilled in the art will determine the needed thickness after consideration of all factors including desired R value, aesthetics, structure geometries, etc.

Once a desired thickness has been determined, the closed cell spray foam 104 is applied upon the prepared exterior wall surface, block 208.

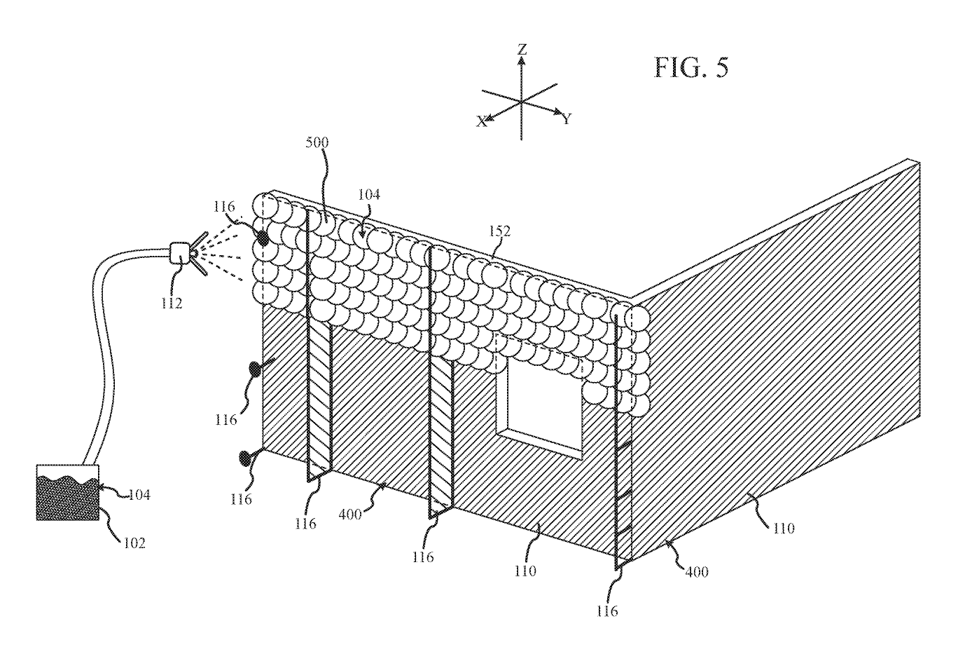

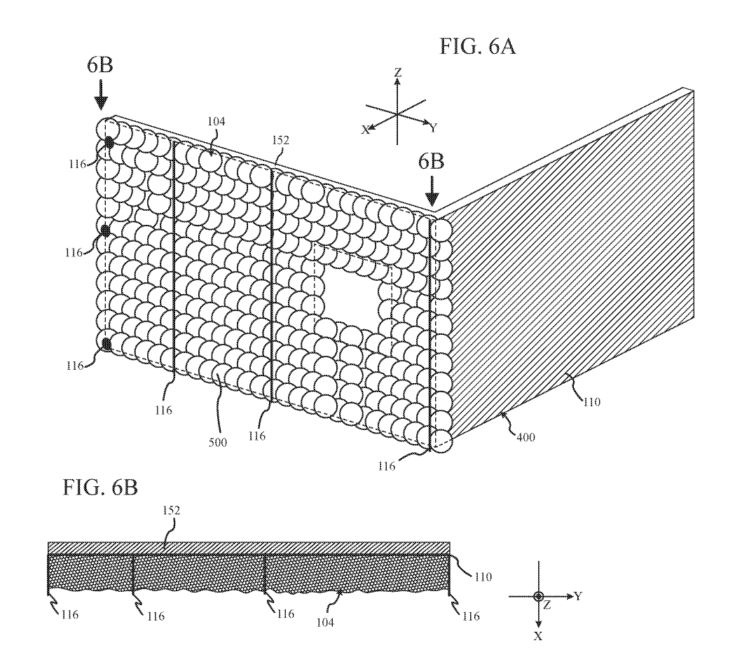

FIG. 5 further illustrates the exemplary application of the closed cell spray foam 104, from the reservoir 102 by the sprayer 112 upon the receiving surface 400, the applied closed cell spray foam 104 shown as spheres 500. As shown, various depth gages 116 have been deployed to assist in ensuring that the closed cell spray foam 104 is applied substantially to the depth desired. FIGS. 6A and 6B provide corresponding perspective and top views of the closed cell spray foam 104 now roughly applied to the building wall 152.

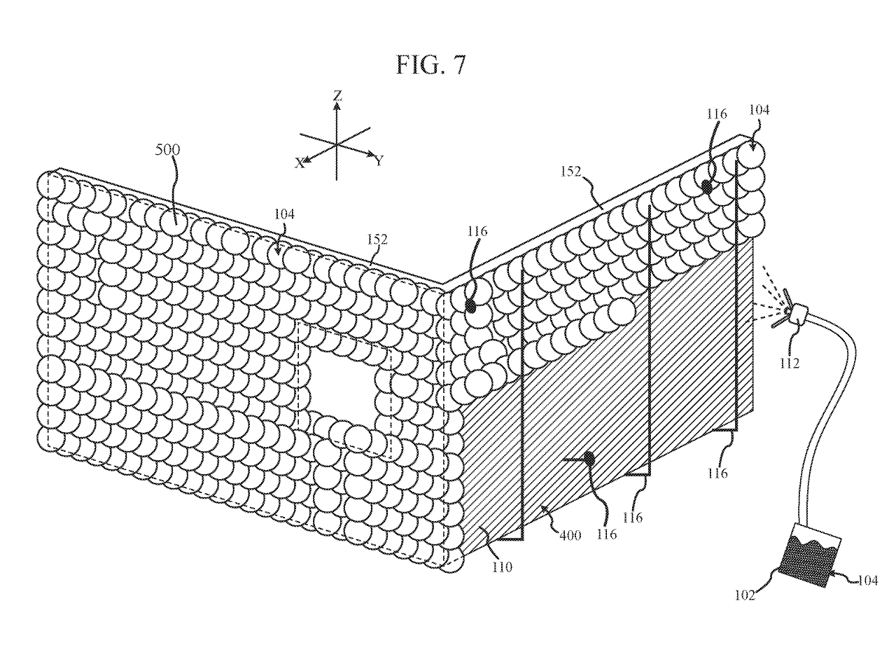

FIG. 7 further illustrates the continuing application of the closed cell spray foam 104 upon the prepared exterior wall surface. In addition, FIG. 7 conceptually illustrates an alternative form of depth gages 116 as brackets. With respect to FIG. 7 as advancing from FIGS. 5 and 6A, 6B, it will be appreciated that for at least one embodiment the depth gages 116 are removed very soon after the application of the closed cell spray foam 104. Indeed, although depth gages such as bolts, or extended nails may be used as shown, as these types of depth gages 116 are disposed within the closed cell spray foam 104, their removal may result in some pulling of the closed cell spray foam 104 and potentially require further redress of the area, such as by filling of any resulting hole with additional closed cell spray foam 104.

Indeed, so as to avoid the possibility of disrupting the adhesion of the closed cell spray foam 104 to the backing material 110, and more specifically the receiving surface 400, for at least one embodiment the depth gages 116 are disposed to the sides of the area being sprayed, such that while effective for insuring proper depth of the closed cell spray foam 104 the depth gages 116 are not in significant contact with the closed cell spray foam 104. Of course, for yet another embodiment, the depth gages 116 may be fabricated from closed cell foam such that they may remain in place and be incorporated as part of the overall closed cell spray foam 104 layer being applied.

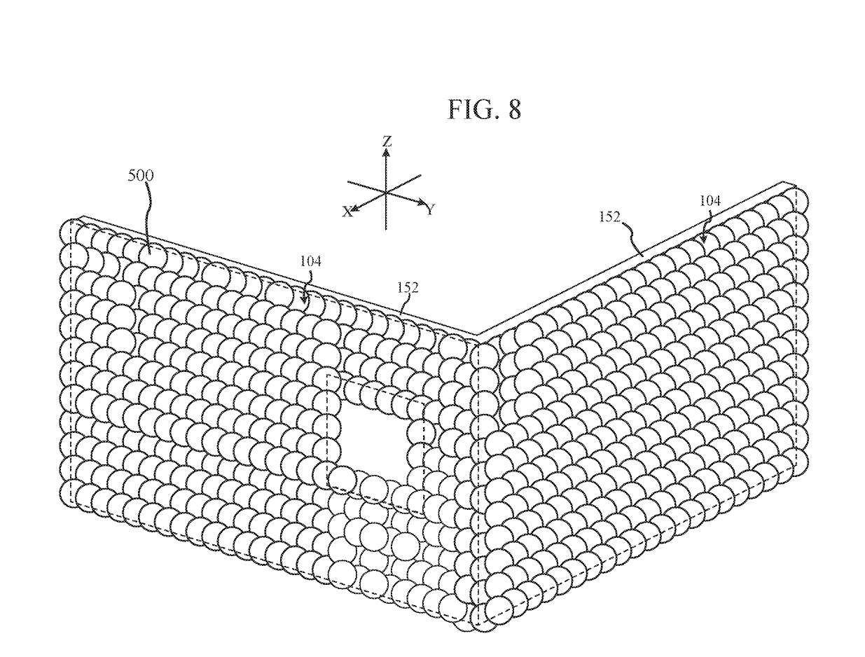

FIG. 8 is presented to show the resulting rough state of the applied closed cell spray foam 104. Given the nature of closed cell spray foam 104 materials, this new exterior surface is very likely to be rough and uneven, conceptually illustrated with the use of spheres 500. As such, it will typically be desired to further process closed cell spray foam 104 to provide a more aesthetically pleasing and desirable exterior. With respect to FIG. 8 it will also be appreciated that for at least one embodiment that the depth gages 116 have been removed. For yet another embodiment where the depth gages 116 are fabricated from closed cell foam, it will be appreciated that they have now been incorporated in the resulting foam layer. Any again, any resulting holes from removal of a depth gage 116 can easily be redressed by directly applying closed cell spray foam 104.

For areas such as existing windows, door frames or other areas or elements where the application of closed cell spray foam 104 is not desired, the use of a shield treated with non-stick spray, parchment paper, plastic wrap may be employed. The commercially available product, “Foam Release” as available from Nox-Crete of Omaha, Nebr., has been used and is high effective. More specifically the treated shield may be disposed adjacent to the surface or element to be shielded from the closed cell spray foam 104, and then removed after the foam is applied, to unmask the surface or element. The cured closed cell spray foam 104 may then be shaped right up to the surface or element for a finished look and appearance.

Returning to FIG. 2, method 200 proceeds with the shaping of the applied closed cell spray foam upon the prepared exterior wall surface to the desired thickness, block 210. The shaping is performed to achieve the desired thickness, aesthetics and contouring of the closed cell spray foam 104. Indeed, the operator may shape the applied closed cell spray foam 104 so as to mimic the appearance of traditional building siding, such as, but not limited to stucco, wood, stone siding or other desired surface appearances.

The shaping may be performed in a number of ways including the use of manual tools, or using power tools. The manual handheld tools or power tools may be utilized in conjunction with a track, attachment post, or guide system to enable desired results utilized by a person skilled in the practice of the present art.

The use of power shaping tools, such as a powered sander, or powered shaving/shaping tools, may comprise hand held tools utilized by a person skilled in the practice of the present art. Additionally, the powered shaping tools may be utilized in combination with a track or attachment system to provide a more efficient and precise method of shaping the closed cell spray foam 104. This track, attachment system or guide system may thus enable an operator to achieve desired results for the exterior surface to mimic traditional building siding as noted above.

Indeed, as shown in FIG. 2, for at least one optional embodiment, method 200 includes applying track guides 120 for temporary attachment adjacent to the exterior wall surface, optional block 212. The track guides may be temporarily attached directly to the posts that are adjacent to, but separate from the building wall 152, or they may be temporarily attached directly to applied closed cell spray foam 104, or even temporarily attached to the underlying wall by passing anchor posts directly through the applied closed cell spray foam 104.

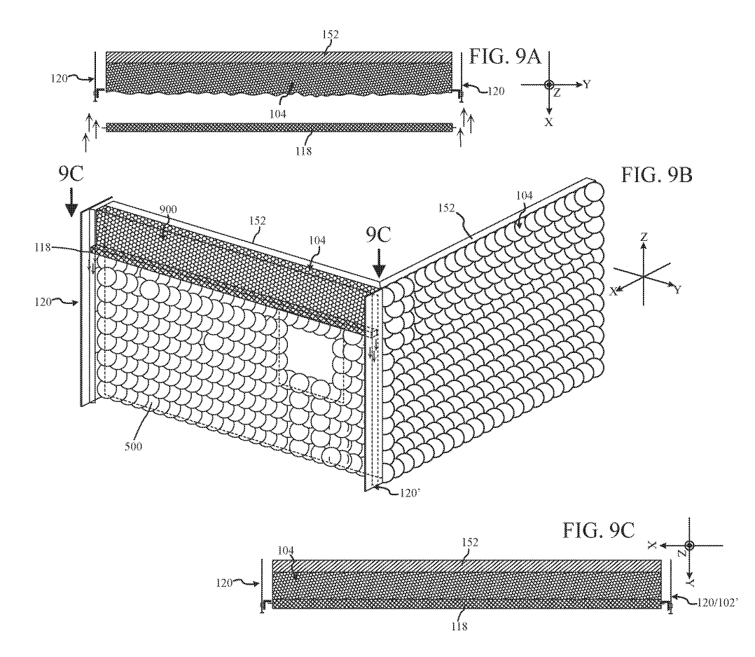

As noted above with respect to FIGS. 1A & 1B, for at least one embodiment the track guides 120 in at least one embodiment are generally adjustable “L” brackets. As is shown in FIG. 9A, the track guides 120 may be temporarily affixed adjacent to the exterior surface so as to facilitate the alignment of a shaping device 118, such as a sanding drum. As is further shown in FIGS. 9B and 9C, the track guides 120 permit precise alignment and application of the shaping device 118 across the entire surface of the applied closed cell spray foam 104 so as to achieve a desired shaped surface 900. With respect to FIG. 9C, track guide 120′ has been illustrated as board, with an inner ledge, so as to further articulate the varying options for track guides 120 that may be used in varying embodiments.

Although FIGS. 9A-9C have been rendered to show the application of the shaping device across the entire lateral surface of the building wall 152, it is to be understood and appreciated that this has been done for ease of illustration and discussion. Moreover, the track guides may be moved, or multiple sets employed, and the shaping device 118 may be directed over the surface of the closed cell spray foam 104 in whatever direction the operator deems most appropriate. As with the potential issue of one or more depth gages 116 leaving a hole, any holes in the applied closed cell spray foam 104 or the resulting shaped surface 900 may easily be redressed by the application of additional shaped closed cell spray foam 104, which again may be sanded or shaved to restore the shaped surface 900.

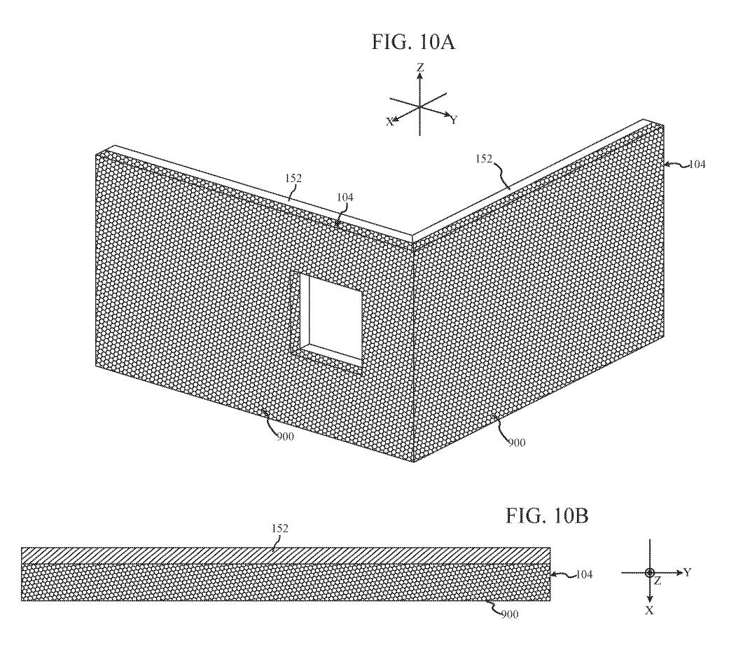

FIG. 10A illustrates the initial refined and uniform shaped surface 900 provided by the shaping process. With respect to FIG. 10B, it may also be appreciated that the resulting thickness of the shaved applied closed cell spray foam 104 may indeed be thicker then the original building wall 152.

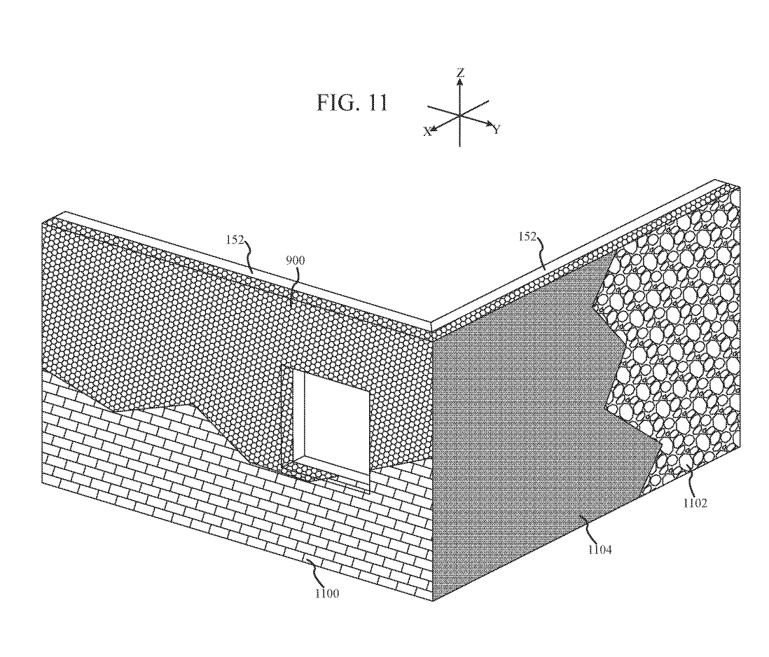

As noted, and shown in FIG. 11 the shaping process may optionally involve texturizing, carving or other processing so as to further impart an exterior surface that mimic traditional building siding. More specifically, in FIG. 11, a portion of the shaped surface 900 has been processed to resemble brick 1100, resemble stone 1102, and resemble stucco 1104. Wood paneling, siding, logs, metal siding and/or other exteriors may likewise be simulated, though not shown.

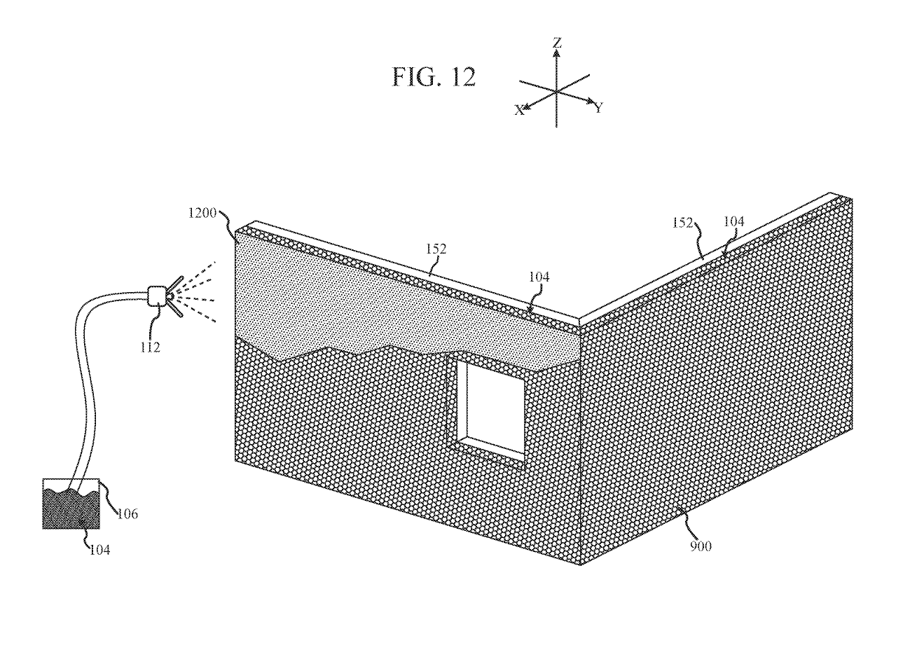

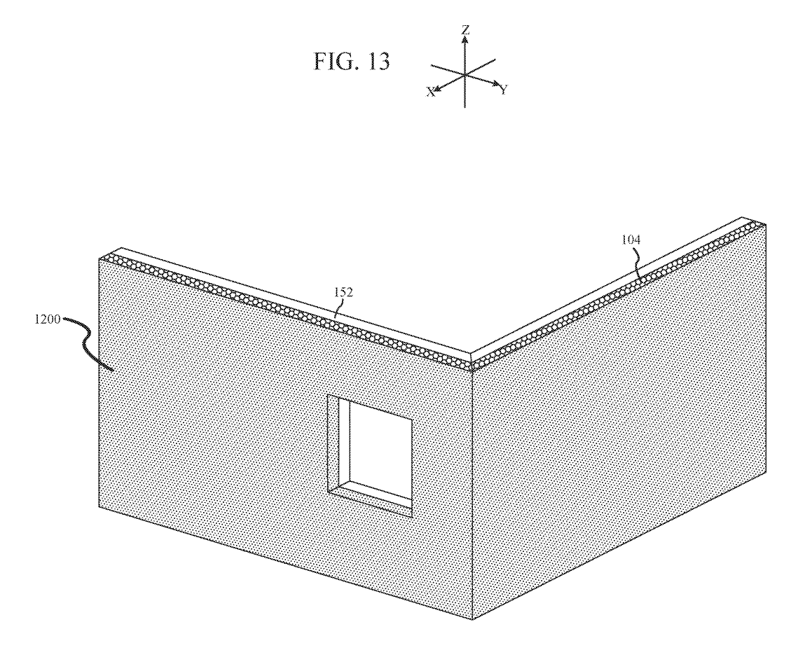

Method 200 continues as shown in FIG. 2 and FIG. 12 with the applying of a weather resistant barrier material 108 over the shaped surface 900, block 214. When applied, this material provides a weather resistant barrier 1200. For at least one embodiment, the weather resistant barrier material 108 is polyrea, sprayed from reservoir 106. The weather resistant barrier 1200 is a thin layer, whose purpose is to provide a weather-proof barrier. Application of the weather resistant barrier material 108, such as polyuria, as a top coating to the previously applied, and potentially now shaped, closed cell spray foam 104 achieves a weather tight, environment resistant exterior for the building that is both insulating and aesthetically pleasing, as is shown in FIG. 13.

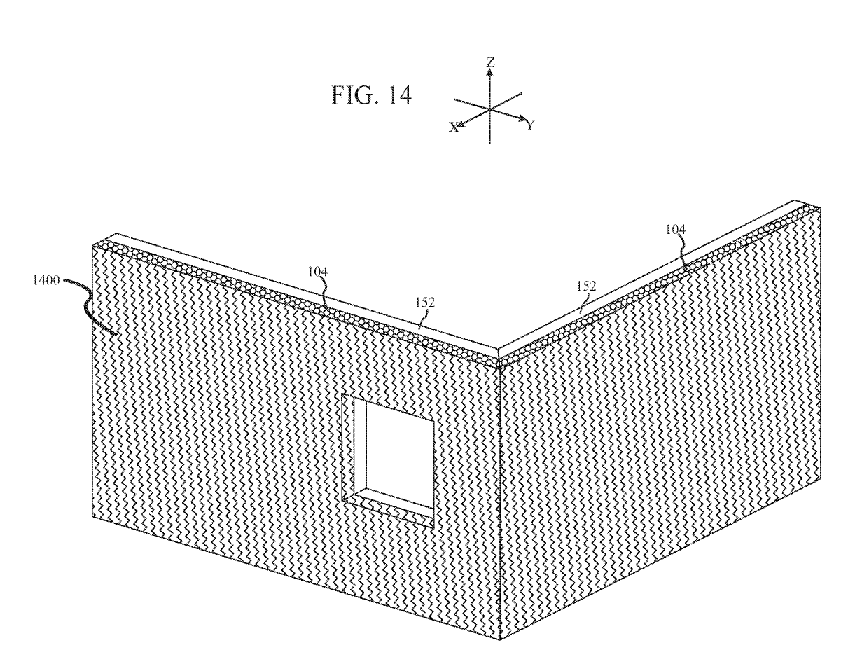

The final major step, shown on FIG. 13, is the application of an exterior grade paint or coating, applied from a reservoir, over top of the weather-proof barrier 1200, block 216. Although, the insulation value of the polyurethane and the polyurea barrier may be considered by some to be a sufficient application, in many case, such as the use of polyuria, the weather-proof barrier 1200 may not be stable in Ultra Violet “UV” light, thus requiring a final protective paint coating. FIG. 14 illustrates a final conceptualization of this applied top-coat of exterior paint 1400, and the resulting exterior insulation and finished surface provided to the walls 152 of the building.

On average, these steps may be completed sequentially with no loss of time in the schedule. In addition, as noted above, the application may be done at temperatures at or below freezing as long as the substrate is dry.

Moreover, for at least one embodiment, the present invention may be summarized as a system for providing exterior insulation and finishing for a building. This system may include backing material to be affixed to an exterior wall structure, the backing material suitable to receive closed cell spray foam; a reservoir of closed cell spray foam to be applied by a sprayer to the backing material when adjoined to an exterior wall surface; at least one shaping device structured and arranged to shape the closed cell spray foam after application to the wall surface; and a reservoir of weather resistant barrier material to be applied by a sprayer to the shaped closed cell spray foam.

Moreover, for at least one embodiment, a method 200 for providing exterior insulation and finishing for a building, is summarized as: preparing an exterior wall surface 154 of a building 150 to accept closed cell spray foam 104; applying closed cell spray foam 104 upon the prepared exterior wall surface 400; shaping the applied closed cell spray foam 104 upon the prepared exterior wall surface 400 to a desired thickness; applying a weather resistant barrier material 108 over the shaped closed cell spray foam 900; and painting the applied weather resistant barrier material 108 with an exterior grade paint.

In summary, the above described SEIF 100 and the practice of method 200 advantageously overcomes many of the shortcomings of traditional exterior finishing. Although resulting in an exterior appearance that may mimic traditional exteriors, such as for example Stucco, SEIF 100 and the practice of method 200 advantageously involves fewer elements and time.

Changes may be made in the above methods, systems and structures without departing from the scope hereof. It should thus be noted that the matter contained in the above description and/or shown in the accompanying drawings should be interpreted as illustrative and not in a limiting sense. Indeed many other embodiments are feasible and possible, as will be evident to one of ordinary skill in the art. The claims that follow are not limited by or to the embodiments discussed herein, but are limited solely by their terms and the Doctrine of Equivalents.

What is claimed:

1. A method for providing exterior insulation and finishing for a building, comprising:
preparing an exterior wall surface of a building to accept closed cell spray foam;
applying closed cell spray foam upon the prepared exterior wall surface;
shaping the applied closed cell spray foam upon the prepared exterior wall surface to a desired thickness;
applying a weather resistant barrier over the shaped closed cell spray foam; and
painting the applied weather resistant barrier with an exterior grade paint.

2. The method of claim 1, wherein the closed cell spray foam is polyurethane closed cell spray foam.

3. The method of claim 1, wherein the weather resistant barrier is polyurea coating.

4. The method of claim 1, wherein finishing the applied closed cell spray foam further includes shaping the applied closed cell spray foam to mimic the appearance of traditional building siding.

5. The method of claim 1, wherein preparing an exterior wall surface further includes affixing a backing material to the exterior wall surface.

6. The method of claim 5, wherein the backing material is selected from the group consisting of: exterior grade OSB, Plywood, Brick, CMU, and landscape fabric.

7. The method of claim 1, wherein the closed cell spray foam is applied to a depth of about 1 inch to about 5 inches.

8. The method of claim 1, further including applying tract guides to the exterior wall surface before applying the closed cell spray foam, the tract guides facilitating consistent shaping of the applied closed cell spray foam.

9. The method of claim 1, wherein the applied closed cell spray foam provides both the exterior of the building and one or more inches of insulation for the building.

10. A system for providing exterior insulation and finishing for a building, comprising:
backing material to be affixed to an exterior wall structure, the backing material suitable to receive closed cell spray foam;
a reservoir of closed cell spray foam to be applied by a sprayer to the backing material when adjoined to an exterior wall surface;
at least one shaping device structured and arranged to shape the closed cell spray foam after application to the wall surface; and
a reservoir of weather resistant barrier material to be applied by a sprayer to the shaped closed cell spray foam.

11. The system of claim 10, further including tract guides structured and arranged for temporary attachment to the exterior wall surface before applying the closed cell spray foam from the reservoir of closed cell spray foam, the tract guides facilitating consistent shaping of the applied closed cell spray foam by the shaping device.

12. The system of claim 10, wherein the shaping tool is fastened to the tract guides.

13. The system of claim 10, further comprising a series of attachment posts facilitating consistent shaping of the applied closed cell spray foam affixed to the exterior wall surface before applying the closed cell spray foam from the reservoir of closed cell spray foam.

14. The system of claim 13, wherein the shaping tool is fastened to the attachment posts.

15. The system of claim 10, wherein the reservoir of closed cell spray is a non-water based product, permitting application to the building at temperatures below 32 degrees Fahrenheit.

16. The system of claim 10, further comprising a reservoir of exterior grade paint.

17. The system of claim 10, wherein as applied to a building, the closed cell spray foam provides an exterior that may be shaped to mimic the appearance of traditional building siding, the applied closed cell spray foam providing both the exterior of the building and one or more inches of insulation for the building.

18. A system for providing exterior insulation and finishing for a building, comprising:
backing material to be affixed to an exterior wall structure, the backing material suitable to receive closed cell spray foam;
a reservoir of closed cell spray foam to be applied by a sprayer to the backing material when adjoined to an exterior wall surface;
at least one shaping device structured and arranged to shape the closed cell spray foam after application to the wall surface;
tract guides structured and arranged for temporary attachment adjacent to the exterior wall surface, the tract guides facilitating consistent shaping of the applied closed cell spray foam by the shaping device; and
a reservoir of weather resistant barrier material to be applied by a sprayer to the shaped closed cell spray foam.

19. The system of claim 18, further comprising a series of attachment posts facilitating consistent shaping of the applied closed cell spray foam affixed to the exterior wall surface before applying the closed cell spray foam from the reservoir of closed cell spray foam.

20. The system of claim 19, further comprising a shaping tool fastened to the attachment posts.

21. The system of claim 18, wherein as applied to a building, the closed cell spray foam provides an exterior that may be shaped to mimic the appearance of traditional building siding, the applied closed cell spray foam providing both the exterior of the building and one or more inches of insulation for the building.
